(19) United States
(12) Patent Application Publication
(10) Pub. No.: US 2022/0148085 A1
(43) Pub. Date: May 12, 2022

(54) METHOD FOR GIVING POINTS ACCORDING TO VIRTUAL CURRENCY REMITTANCE

(71) Applicants: Young Taek PARK, Gochang-gun (KR); Eun Cheon CHOE, Jeonju-si (KR); Hyun Woo CHUNG, Seongnam-si (KR)

(72) Inventors: Young Taek PARK, Gochang-gun (KR); Eun Cheon CHOE, Jeonju-si (KR); Hyun Woo CHUNG, Seongnam-si (KR)

(21) Appl. No.: 17/438,420

(22) PCT Filed: Jun. 12, 2020
(86) PCT No.: PCT/KR2020/007670

§ 371 Date: Sep. 11, 2021

(30) Foreign Application Priority Data
Jun. 20, 2019 (KR) 10-2019-0073325

(51) Int. Cl. G06Q 40/04; G06Q 40/02; G06Q 30/02

(52) U.S. Cl. CPC G06Q 40/04; G06Q 30/0215; G06Q 40/02

(57) ABSTRACT

The present invention relates to a method for giving points according to virtual currency remittance, the method comprising the steps of: (a) withdrawing a virtual currency having a certain value from a virtual currency remittance account of a sender on an exchange server and then depositing a virtual currency having a value equal to the certain value into a virtual currency receiving account of a recipient on the exchange server; and (b) calculating points by applying a preset point ratio to the virtual currency having the certain value in step (a) on the exchange server and depositing a variable virtual currency for points corresponding to a value equal to the value of the points into a variable virtual currency receiving account of the sender, wherein the variable virtual currency for points is a variable virtual currency selected from various kinds of variable virtual currencies preset on the exchange server.

### TECHNICAL FIELD

The present invention relates to a method for giving points according to virtual currency remittance associated with virtual currency remittance, and more particularly, to a method for giving points according to virtual currency remittance, in which a virtual currency having a certain value withdrawn from a remittance account of a sender is deposited into a virtual currency receiving account of a recipient through an exchange server and then the recipient returns some value of the certain value remitted as the virtual currency to the recipient as points to the sender, wherein some value is returned as any kind of variable virtual currency selected randomly from various kinds of variable virtual currencies so as to increase the demand of the various kinds of variable virtual currencies. With the exchange activation of variable virtual currencies, the demand for the various kinds of variable virtual currencies may be increased.

### BACKGROUND ART

When there was no currency, exchange and barter were performed, but over time, coins and banknotes have occurred, and as technology development and digitization are gradually performed, the concept of new currencies such as virtual currencies have appeared. These virtual currencies mean currencies which have no substance in a virtual environment literally unlike real currencies (coins, banknotes) to be actually exchanged.

These virtual currencies may be classified into non-variable virtual currencies and variable virtual currencies, and the non-variable virtual currencies are digitalized currencies fixed one-to-one on legal currencies. On the other hand, the variable virtual currencies are digitized assets designed to be enabled as exchange means, and digitalized currencies of which the exchange value is not fixed to the legal currency one-to-one and is fluctuated by the demand and supply in the market. Typical variable virtual currencies include Bitcoin, Ethereum, Ripple, etc.

In recent years, interest in the variable virtual currencies is rapidly increasing as means of transfer of assets with complete anonymity and unauthorized by the government and investment assets, and suddenly rising as means of remitting payment in everyday life.

As a related art of disclosing a payment system using virtual currency exchange, Korean Patent Registration No. 10-1813256 will be described.

The related art relates to a payment system using virtual currency exchange, and an object of the present invention is to make a payment through virtual currencies that are linked with various payment methods such as debit cards, credit cards, mobiles, etc., even in online/offline stores in which virtual currencies are unavailable.

Specifically, there is disclosed a payment system using a virtual currency which includes a payment method of a user possessing a virtual currency; and a virtual currency exchange server which is linked with a payment server, confirms a payment amount from the payment server at the time of a request for payment by the payment method to send the requested payment amount to a payment account of the payment method, deducts a virtual currency corresponding to the payment amount from the virtual currency of the user, but sends the deducted virtual currency in advance as a deposit of a deposit account before sales, sends the deducted virtual currency as a payment for sales at the time of the request for payment, or calculates a total amount of the requested payment amount on a preset date to send the total amount in a lump sum.

However, according to the related art, there is disclosed only a technical feature of the payment system through the virtual currency exchange, but there is disclosed no technical feature capable of promoting the virtual currency exchange. Furthermore, there is disclosed no technical feature capable of increasing the demand of variable virtual currencies so that variable virtual currencies as well as non-variable virtual currencies are intervened on the payment system in the process of promoting the virtual currency exchange.

Accordingly, in the virtual currency market in which various kinds of variable virtual currencies are emerging, there is a need of a technical feature of increasing the demand of various kinds of variable virtual currencies while promoting the exchange of the various kinds of variable virtual currencies.
[Patent Document 1] KR10-1813256 B

### DISCLOSURE

### Technical Problem

In addition to the aforementioned related art, an object of the present invention is to provide a method for giving points according to virtual currency remittance capable of increasing the demand of variable virtual currencies while promoting virtual currency exchange and promoting the exchange of the variable virtual currency according to the increased demand.

### Technical Solution

According to an aspect of the present invention, there is provided a method for giving points according to virtual currency remittance, the method including the steps of: (a) withdrawing a virtual currency having a certain value from a virtual currency remittance account of a sender on an exchange server and then depositing a virtual currency having a value equal to the certain value into a virtual currency receiving account of a recipient on the exchange server; and (b) calculating points by applying a preset point ratio to the virtual currency having the certain value in step (a) on the exchange server and depositing a variable virtual currency for points corresponding to a value equal to the value of the points into a variable virtual currency receiving account of the sender, wherein the variable virtual currency for points is a variable virtual currency selected from various kinds of variable virtual currencies preset on the exchange server.

Preferably, the variable virtual currency for points may be two or more any kinds of variable virtual currencies randomly selected from various kinds of variable virtual currencies preset on the exchange server.

Preferably, step (b) may include (b-1) receiving a point remittance request by the recipient on the exchange server so that the variable virtual currency for points corresponding to the value of points in step (b) is deposited into the variable virtual currency receiving account of the sender; (b-2) randomly selecting two or more any kinds of variable virtual currencies from various kinds of variable virtual currencies preset on the exchange server; and (b-3) depositing the two or more any kinds of variable virtual currencies randomly selected in step (b-2) into the variable virtual currency receiving account of the sender, but depositing the any kind of variable virtual currency corresponding to a value equal to the value of points in step (b).

Preferably, the variable virtual currency for points may be two or more kinds of variable virtual currencies selected from various kinds of variable virtual currencies preset on the exchange server, the variable virtual currency for points may be preset by a recipient so that one or more specific kinds of variable virtual currencies are selected from various kinds of variable virtual currencies preset on the exchange server, and the variable virtual currency for points may include any kind of variable virtual currency randomly selected from the various kinds of variable virtual currencies preset on the exchange server and the one or more specific kinds of variable virtual currencies.

Preferably, the variable virtual currency for points may include at least one or more any kinds of variable virtual currencies randomly selected from various kinds of variable virtual currencies preset on the exchange server.

### Advantageous Effects

According to the present invention, it is possible to promote the exchange of the variable virtual currency while increasing the convenience of remittance and increase the demand thereof. As a result, the points are given according to virtual currency remittance, wherein various kinds of variable virtual currencies are given as points, thereby promoting the exchange of virtual currencies as a payment method and promoting the exchange of variable virtual currencies by increasing the demand of the variable virtual currencies.

Specifically, the recipient gives the points to the sender according to virtual currency remittance, but any kind of variable virtual currency randomly selected from various kinds of variable virtual currencies is given as a variable virtual currency for points, thereby promoting the exchange of the variable virtual currency by increasing the demand of the various kinds of variable virtual currencies.

### DESCRIPTION OF DRAWINGS

FIG. 1 is a diagram schematically illustrating a first embodiment of a method for giving points according to virtual currency remittance according to the present invention.

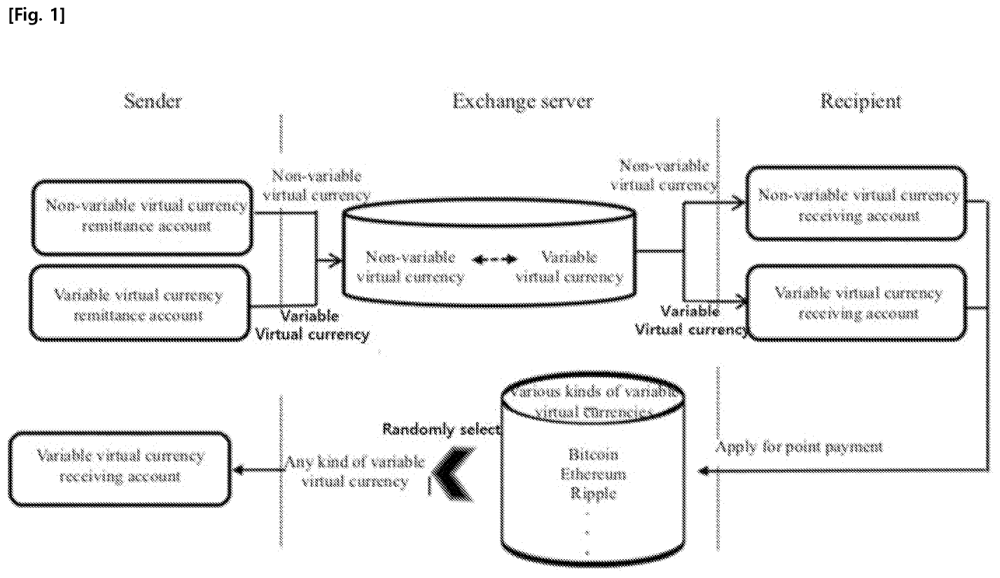

FIG. 2 is a diagram schematically illustrating a second embodiment of a method for giving points according to virtual currency remittance according to the present invention.

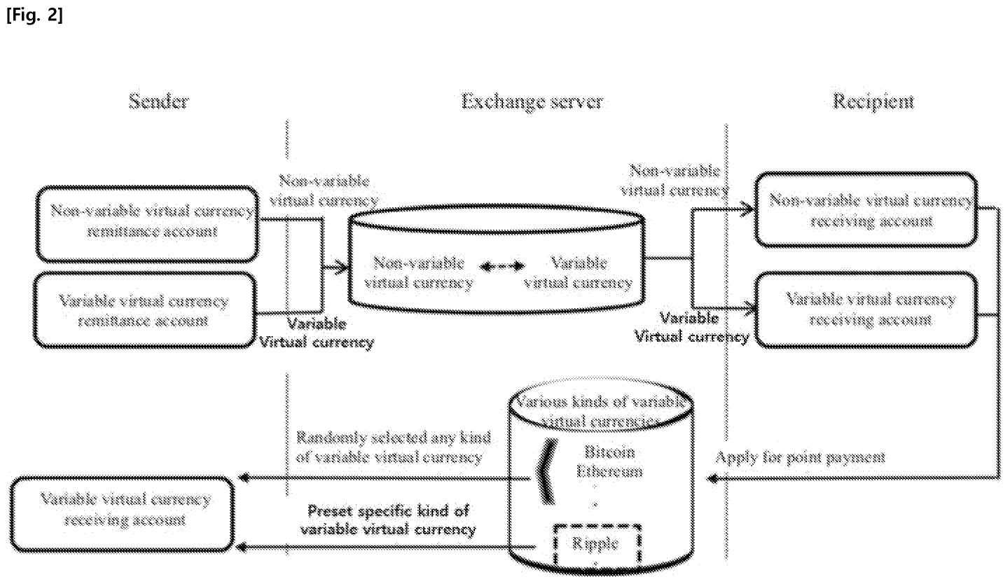

### MODES FOR THE INVENTION

Hereinafter, preferred embodiments of the present invention will be described in detail with reference to the accompanying drawings. In this process, thicknesses of lines and sizes of constituent elements illustrated in the drawings, and the like may be exaggerated for clarity and ease of description. Further, terms to be described below, as terms which are defined in consideration of functions in the present invention may vary depending on the intention or custom of a user or an operator. Accordingly, definitions of the terms need to be described based on contents throughout this specification.

In a virtual currency remittance method according to the present invention, “virtual currency” includes a non-variable virtual currency and a variable virtual currency. The “non-variable virtual currency” refers to a digitalized currency of which an exchange value is fixed to a legal currency one to one.

The “variable virtual currency” is a digitized asset designed to be enabled as an exchange means, and a digitalized currency of which the exchange value is not fixed to a legal currency one-to-one and is fluctuated by the demand and supply in the market. Exemplary variable virtual currencies include Bitcoin, Ethereum, Ripple, etc.

In the present invention, the “point” refers to a value at any ratio to a certain value remitted from a sender to a recipient and refers to a value returned to the sender by the recipient so as to be sold by the intention of the sender. Thus, in the present invention, the “point ratio” is a ratio of the value of points to the certain value remitted to the recipient by the sender. Of course, the value may be represented as a legal currency, a non-variable virtual currency, or a variable virtual currency.

The remittance of the virtual currency according to the present invention is performed by a method of withdrawing a virtual currency having a certain value from a virtual currency remittance account of a sender on an exchange server and then depositing the virtual currency having a value equal to the certain value into a virtual currency receiving account of a recipient on the exchange server.

Specifically, according to a remittance request of the sender, on the exchange server, a non-variable virtual currency having a certain value may be withdrawn from a non-variable virtual currency remittance account of the sender or a variable virtual currency having a certain value may be withdrawn from a variable virtual currency remittance account of the sender.

In this way, the non-variable virtual currency or variable virtual currency having the certain value withdrawn from the exchange server may be deposited into a non-variable virtual currency receiving account of the recipient or a variable virtual currency receiving account of the recipient as it is. Alternatively, of course, the non-variable virtual currency or variable virtual currency having the certain value withdrawn from the exchange server may be converted into another non-variable virtual currency or variable virtual currency having a value equal thereto on the exchange server, and the converted another non-variable virtual currency or variable virtual currency may be deposited into the non-variable virtual currency receiving account or the variable virtual currency receiving account of the recipient.

The non-variable virtual currency remittance account and the variable virtual currency remittance account of the sender may be virtual accounts generated unlike existing bank accounts or existing bank accounts, and alternatively, of course, may be accounts in any form known to those skilled in the art which are applied to implement the virtual currency remittance method.

The non-variable virtual currency receiving account and the variable virtual currency receiving account of the recipient may be virtual accounts generated unlike existing bank accounts or existing bank accounts, and alternatively, of course, may be accounts in any form known to those skilled in the art which are applied to implement the virtual currency remittance method.

Other remittance and receiving methods of the non-variable virtual currency and the variable virtual currency are based on the related arts.

As the method for giving the points according to the virtual currency remittance, a method for giving a variable virtual currency selected from various kinds of variable virtual currencies as points to the sender by the recipient will be described.

The recipient receiving a virtual currency having a value equal to the virtual currency having the certain value remitted from the sender gives the sender points calculated by applying a preset point ratio to the virtual currency having the certain value remitted from the sender, and may request point remittance so that the variable virtual currency corresponding to a value equal to the value of the points is deposited into the variable virtual currency receiving account of the sender for points.

That is, on the exchange server, the point ratio is preset by the recipient, and the preset point ratio is applied to the virtual currency having the certain value remitted from the sender to calculate points, and a point remittance request by the recipient may be received to the exchange server so that the variable virtual currency for the points corresponding to the value equal to the value of the calculated points may be deposited into the variable virtual currency receiving account of the sender.

Of course, the point ratio for the virtual currency having the certain value remitted from the sender may be preset by the recipient, and the point ratio may be changed by the recipient periodically or in real time.

On the exchange server receiving the point remittance request, of course, the non-variable virtual currency corresponding to the value equal to the value of points may be withdrawn from the non-variable virtual currency receiving account of the recipient or the variable virtual currency corresponding to the value equal to the value of points may be withdrawn from the variable virtual currency receiving account of the recipient. Further, of course, the virtual currency corresponding to the value equal to the value of points may be withdrawn from a separate account of the recipient other than the non-variable virtual currency receiving account or variable virtual currency receiving account of the recipient.

On the exchange server, various kinds of variable virtual currencies may be preset. Of course, an exchange manager may delete some variable virtual currencies from the various kinds of preset variable virtual currencies or add other variable virtual currencies.

A first embodiment of selecting a variable virtual currency for points from various kinds of variable virtual currencies preset on the exchange server and a method for giving points according to the first embodiment will be described.

By the point remittance request by the recipient received from the exchange server, any kind of variable virtual currency is randomly selected from the various kinds of variable virtual currencies preset on the exchange server. Any kind of variable virtual currency selected as such is deposited into the variable virtual currency receiving account of the sender as the variable virtual currency for points, and any kind of variable virtual currency corresponding to the value equal to the value of points is deposited.

At this time, any kind of variable virtual currency randomly selected may be two or more any kinds of variable virtual currencies.

That is, when the point remittance request from the recipient is received on the exchange server, among various kinds of variable virtual currencies preset on the exchange server, two or more any kinds of variable virtual currencies are randomly selected. The two or more any kinds of variable virtual currencies randomly selected as such are deposited into the variable virtual currency receiving account of the sender, wherein the two or more any kinds of variable virtual currencies corresponding to the value equal to the value of points are deposited.

When there is the point remittance request from the recipient to the exchange server, the demand on each of various kinds of variable virtual currencies preset on the exchange server is to be increased without concentrating on some variable virtual currencies. That is, the variable virtual currency for points is selected from the various kinds of variable virtual currencies, and even in other variable virtual currencies as well as any one variable virtual currency concentrated according to the point payment, the demand may occur.

Any one variable virtual currency preset once on the exchange server where the method for giving points according to the virtual currency remittance according to the present invention is performed may be selected as a variable virtual currency for points by the method for giving points, and the demand of the selected variable virtual currency is increased, and as a result, the exchange of the selected variable virtual currency is promoted. In this situation, in order to increase the demand and promote the exchange, it is required that any one variable virtual currency may be preset on the exchange server.

When the point remittance request of the recipient is received to the exchange server, the value of points is divided evenly or unevenly on the exchange server, and two or more any kinds of variable virtual currencies are randomly selected according to the number of divided values.

The two or more any kinds of variable virtual currencies are deposited into the variable virtual currency receiving account of the sender, wherein two or more any kinds of variable virtual currencies corresponding to a value equal to each divided value are deposited into the variable virtual currency receiving account of the sender. That is, the two or more any kinds of variable virtual currencies corresponding to the value equal to each divided value are deposited into the variable virtual currency receiving account of the sender as the variable virtual currencies for points.

The variable virtual currency receiving account of the sender may be, of course, a variable virtual currency receiving account opened directly by the sender or a variable virtual currency receiving account opened for each sender by the recipient. Alternatively, of course, the variable virtual currency remittance account of the sender may be used as the receiving account. Further, the variable virtual currency receiving account of the sender may be a virtual account generated unlike existing bank accounts or an existing bank account, and alternatively, of course, may be an account in any form known to those skilled in the art which are applied to implement the virtual currency remittance method.

A second embodiment of selecting a variable virtual currency for points from various kinds of variable virtual currencies preset on the exchange server and a method for giving points according to the second embodiment will be described.

A variable virtual currency for points may be preset by a recipient so that one or more specific kinds of variable virtual currencies are selected from various kinds of variable virtual currencies preset on the exchange server.

For example, the recipient may preset a specific kind of variable virtual currency so that Ripple, etc. are necessarily selected from various kinds of variable virtual currencies such as Bitcoin, Ethereum, Ripple, etc. Depending on the holding condition of the variable virtual currencies of the recipient, the preference for the specific kind of variable virtual currency may vary according to a method for receiving the variable virtual currency of the recipient or a method for giving points.

However, when the point remittance request of the recipient is received to the exchange server, on the exchange server, the variable virtual currency for points is selected. When only one or more specific kinds of variable virtual currencies preset by the recipient are selected, as a key variable virtual currency is concentrated in the variable virtual currency market, it is difficult to increase the demand of the remaining variable virtual currencies, and as a result, it is difficult to promote the exchange of the remaining variable virtual currencies.

Accordingly, once in the case of the various kinds of variable virtual currencies preset on the exchange server, in case that the variable virtual currency preset by the recipient is selected as the variable virtual currency for points, it is necessary to be limited to some values among the point values so that the demand may necessarily occur.

That is, some of the point values are limited to one or more specific types of variable virtual currencies corresponding to a value equal to some values. The remaining values of the point values are necessarily at least one or more any kinds of variable virtual currencies randomly selected from various kinds of preset variable virtual currencies except for one or more specific types of variable virtual currencies.

Accordingly, when the variable virtual currency for points is deposited into the variable virtual currency receiving account of the sender, some values of the point values are deposited as one or more specific types of variable virtual currencies corresponding to a value equal to some values and the remaining values are deposited as at least one or more any types of variable virtual currencies corresponding to a value equal to the remaining values. The at least one or more any types of variable virtual currencies are randomly selected from various kinds of preset variable virtual currencies except for one or more specific types of variable virtual currencies.

The variable virtual currency receiving account of the sender may be, of course, a receiving account opened directly by the sender or a receiving account opened for each sender by the recipient. Alternatively, of course, the variable virtual currency remittance account of the sender may be used as the receiving account. Further, the variable virtual currency receiving account of the sender may be a virtual account generated unlike existing bank accounts or an existing bank account, and alternatively, of course, may be an account in any form known to those skilled in the art which are applied to implement the virtual currency remittance method.

In the present invention, the exchange server may be not only a physically connected server, but also a plurality of exchange servers linked via a network.

When the exchange between the sender and the recipient occurs, the recipient will provide incentives of the exchange to the sender as a customer with the point payment. Furthermore, the recipient selects any kind of variable virtual currency selected randomly from various kinds of variable virtual currencies when giving the points to the sender or selects any kind of variable virtual currency selected randomly in addition to one or more specific kinds of variable virtual currencies preset by the recipient to give points with any kind of variable virtual currency or any kind and specific kind of variable virtual currencies corresponding to the value equal to the value of points, thereby increasing the demand of the various kinds of variable virtual currencies.

Furthermore, a large number of supplier of the various kinds of variable virtual currencies participate in the exchange where the point payment method according to the present invention is performed in order to supply their variable virtual currencies according to the demand, thereby promoting the exchange of variable virtual currencies in the exchange.

Hereinabove, in the present specification, although the present invention has been described with reference to the embodiments illustrated in the drawings so as to be easily understood and reproduced by those skilled in the art, it is just illustrative, and it will be understood to those skilled in the art that various modifications and other equivalent embodiments can be made from the embodiments of the present invention. Therefore, the scope of the present invention should be determined by the appended claims.

1. A method for giving points according to virtual currency remittance comprising the steps of:
(a) withdrawing a virtual currency having a certain value from a virtual currency remittance account of a sender on an exchange server and then depositing a virtual currency having a value equal to the certain value into a virtual currency receiving account of a recipient on the exchange server; and
(b) calculating points by applying a preset point ratio to the virtual currency having the certain value in step (a) on the exchange server and depositing a variable virtual currency for points corresponding to a value equal to the value of the points into a variable virtual currency receiving account of the sender,
wherein the variable virtual currency for points is a variable virtual currency selected from various kinds of variable virtual currencies preset on the exchange server, and
the variable virtual currency for points is two or more any kinds of variable virtual currencies randomly selected from various kinds of variable virtual currencies preset on the exchange server, and
step (b) includes
(b-1) receiving a point remittance request by the recipient on the exchange server so that the variable virtual currency for points corresponding to the value of points in step (b) is deposited into the variable virtual currency receiving account of the sender and then dividing the value of the remittance-requested points into two or more values of points on the exchange server;
(b-2) randomly selecting two or more any kinds of variable virtual currencies from various kinds of variable virtual currencies preset on the exchange server so as to correspond to the number of values of points divided in step (b-1); and
(b-3) depositing the two or more any kinds of variable virtual currencies randomly selected in step (b-2) into the variable virtual currency receiving account of the sender, but depositing the two or more any kinds of variable virtual currencies corresponding to the value equal to each value of two or more points divided in step (b-2).

2. A method for giving points according to virtual currency remittance comprising the steps of:
(a) withdrawing a virtual currency having a certain value from a virtual currency remittance account of a sender on an exchange server and then depositing a virtual currency having a value equal to the certain value into a virtual currency receiving account of a recipient on the exchange server; and
(b) calculating points by applying a preset point ratio to the virtual currency having the certain value in step (a) on the exchange server and depositing a variable virtual currency for points corresponding to a value equal to the value of the points into a variable virtual currency receiving account of the sender,
wherein the variable virtual currency for points is a variable virtual currency selected from various kinds of variable virtual currencies preset on the exchange server, and
the variable virtual currency for points is two or more kinds of variable virtual currencies selected from various kinds of variable virtual currencies preset on the exchange server, and
the variable virtual currency for points is preset by a recipient so that one or more specific kinds of variable virtual currencies are selected from various kinds of variable virtual currencies preset on the exchange server,
step (b) includes
(b-4) receiving a point remittance request by the recipient on the exchange server so that the variable virtual currency for points corresponding to the value of points in step (b) is deposited into the variable virtual currency receiving account of the sender and then dividing the value of the remittance-requested points into two or more values of points on the exchange server;
(b-5) selecting two or more kinds of variable virtual currencies from various kinds of variable virtual currencies preset on the exchange server so as to correspond to the number of values of points divided in step (b-1), but selecting any kind of variable virtual currency randomly selected from the various kinds of variable virtual currencies preset on the exchange server and the one or more specific kinds of variable virtual currencies to be included; and
(b-6) depositing the any kind of variable virtual currency randomly selected and the one or more specific kinds of variable virtual currencies in step (b-5) into the variable virtual currency receiving account of the sender, but depositing the any kind of variable virtual currency randomly selected and the one or more specific kinds of variable virtual currencies corresponding to a value equal to each value of two or more points divided in step (b-5).
